(19) United States
(12) Patent Application Publication
(10) Pub. No.: US 2025/0066943 A1
(43) Pub. Date: Feb. 27, 2025

(54) METAL-NANOPARTICLE-FREE SURFACE-ENHANCED RAMAN SCATTERING SUBSTRATE, AND A METHOD OF MANUFACTURING THE SAME

(71) Applicant: NATIONAL CHENG KUNG UNIVERSITY, Tainan City (TW)

(72) Inventors: Chen-Kuei CHUNG, Tainan City (TW); Chung-Yu YU, Taichung City (TW); Chin-An KU, Tainan City (TW)

(73) Assignee: NATIONAL CHENG KUNG UNIVERSITY, Tainan City (TW)

(21) Appl. No.: 18/386,176

(22) Filed: Nov. 1, 2023

(30) Foreign Application Priority Data
Aug. 25, 2023 (TW) 112132167

(51) Int. Cl. C25D 11/12; B82Y 15/00

(52) U.S. Cl. CPC C25D 11/12; B82Y 15/00

(57) ABSTRACT

The present invention provides a metal-nanoparticle-free surface-enhanced Raman scattering substrate, which comprises: an anodic aluminum oxide substrate with three-dimensional cavities, and a metal nano-film on the anodic aluminum oxide substrate. The surface-enhanced Raman scattering substrate of the present invention does not need to use metal nanoparticles, but instead uses a structure of metal nanofilm to generate a surface plasmonic resonance. Therefore, compared with the traditional surface-enhanced Raman scattering substrate with an addition of metal nanoparticles, the surface-enhanced Raman scattering substrate of the present invention has better uniformity, stability and reproducibility. The present invention utilizes an anodic aluminum oxide substrate with three-dimensional cavities, so that the surface-enhanced Raman scattering substrate has high sensitivity, high stability, and high reproducibility. The present invention also provides a method of manufacturing the substrate with simple procedure, which allows a rapid manufacturing process and makes the surface-enhanced Raman scattering substrate with three-dimensional cavities.

### CROSS-REFERENCE TO RELATED APPLICATIONS

This application claims the benefit of priority of Taiwan Application Number TW112132167, filed on 25 Aug. 2023, which is herein incorporated by reference in its entirety.

### TECHNICAL FILED

The present invention relates to a metal-nanoparticle-free surface-enhanced Raman scattering substrate and a method of manufacturing the same, particularly a metal-nanoparticle-free surface-enhanced Raman scattering substrate comprising an anodic aluminum oxide substrate with three-dimensional cavities and a metal nano-film on the anodic aluminum oxide substrate, and a method of manufacturing the same.

### BACKGROUND

Surface-enhanced Raman scattering (SERS) is a spectroscopic technique for fast, non-destructive, non-contact optical analysis based on molecular bonding of analytes. SERS utilizes a surface plasmonic resonance effect generated by laser stimulation on precious metals which are attached on a micro-nanometer surface structure: laser illumination generates a local electromagnetic field, resulting in local charge separation on the metal surface, which may amplify the Raman signal. Therefore, SERS has a wide range of applications in analytical sciences, materials physics, and biomedicine. Due to its high sensitivity, non-destructiveness, and ability to directly analyze liquid samples, SERS has been further applied in fields such as agriculture research, environmental monitoring, biological molecule detection, and medical health, making it a highly promising analytical tool.

Traditional SERS technique uses metal-nanoparticles such as silver or gold nanoparticles for Raman enhancement. However, metal-nanoparticles are difficult to control, and the shape and gap are much likely to change after laser illumination. Therefore, traditional SERS substrates have poor reproducibility and uniformity. For example, in CN102621122A, SERS sensing capability is enhanced by electroplating and depositing plural metal-nanoparticles at the bottom of the cavities of a porous anodized aluminum oxide film. However, this process is cumbersome and requires etching with acid solution or destroying the barrier layer of the aluminum oxide, which may cause pollution to the environment. Furthermore, the use of metal-nanoparticles makes the reproducibility and uniformity of the SERS substrate very poor.

Anodic aluminum oxide (AAO) is a porous nanomaterial. Compared to using silicon, glass, or polymers as a substrate, the use of AAO eliminates the need for complex and expensive lithography and etching processes for SERS substrates.

On the other hand, according to TWI731600, a SERS substrate prepared from an AAO substrate exhibits enhanced electric fields along the AAO nanopores, which may enhance the sensing capability of the SERS. However, although the SERS substrate comprising an AAO substrate with two-dimensional structure has an enhanced effect, it still has limitations in detecting extremely low concentrations of analytes, and there are still difficulties in application.

Accordingly, though there have been many researches on SERS substrate, there is still a need for a SERS substrate that is made by simpler process, costs lower, and is non-contaminating, high in reproducibility, high in uniformity, and capable of detecting extremely low concentrations, i.e., having a stronger sensing capability.

### SUMMARY

Accordingly, the present invention provides a metal-nanoparticle-free SERS substrate and a method of manufacturing the same, in order to provide a simpler, low-cost and non-contaminating manufacturing process. The SERS substrate prepared with the manufacturing process comprises an AAO substrate with three-dimensional cavities, which is capable of detecting extremely low concentrations, and has high reproducibility and uniformity.

The SERS substrate of the present invention adopts a metal nano-film instead of metal-nanoparticles to avoid changes in the shape and gap of the metal-nanoparticles after laser illumination, thus improving the reproducibility and uniformity of the SERS substrate.

Moreover, the SERS substrate of the present invention comprises an AAO substrate with three-dimensional cavities, and the present invention may obtain a SERS substrate with strong sensing capability by the following mechanism: Compared with the substrate with two-dimensional structure, the three-dimensional AAO cavities may generate more and stronger hotspots distributed in the third dimension, and thus generate higher sensitivity.

Specifically, an aspect of the present invention provides a metal-nanoparticle-free SERS substrate, comprising:
an AAO substrate with three-dimensional cavities; and
a metal nano-film on the AAO substrate.

The three-dimensional cavities comprise nano-and-micro-scale pits with nanopores, or nanospikes around nanocavities; and the metal nano-film is on the three-dimensional cavities.

In some embodiments, the micro-scale pits of the three-dimensional cavities have an average diameter of 0.1 to 5 μm, preferably 0.3 to 2 μm, more preferably 0.5 to 1.5 μm, so that more multi-reflection may occur and allow more photons to collide inelastically with the probe molecules on the SERS substrate, and thereby amplify Raman signals.

In some embodiments, the AAO substrate has an average roughness of 0.1 to 2 μm, preferably 0.4 to 1 μm, more preferably 0.8 to 1 μm. Compared with substrates with two-dimensional structure which would reflect most of the incident light, an AAO substrate with the roughness may increase the inelastic collision of photons with the probe molecules on the SERS substrate, and thereby amplify Raman signals.

In some embodiments, the metal nano-film has a thickness of 6 to 30 nm, preferably 10 to 20 nm. By adopting metal nano-film instead of metal-nanoparticles, changes in the shape and gap of the metal-nanoparticles after laser illumination may be avoided, which may enhance the uniformity and reproducibility of the SERS substrate, produce localized surface plasmonic resonance, enhance the sensitivity of analyzing composition of material, and enable SERS sensing on the AAO substrate.

In some embodiments, the nanopores have an average gap between the nanopores of 10 to 300 nm, preferably 10 to 100 nm. By reducing the average gap between the nanopores, the strength of the hotspot generated by the three-dimensional cavities of the AAO substrate may be increased and thereby enhance Raman signals.

In some embodiments, the SERS substrate may have a low detection limit of 1×10⁻¹⁰ M for methylene blue. Therefore, the present invention may be applied in industries where water quality testing is required to avoid the hazards of water pollution.

In some embodiments, the SERS substrate may have a low detection limit of 0.05 ppm for melamine. Since the WHO-recommended criteria is that the concentration of melamine should be lower than 1 ppm, the present invention may be used to detect the residues of melamine.

Furthermore, the present invention provides a metal-nanoparticle-free AAO substrate with three-dimensional cavities manufactured by methods comprising steps of specific electrochemical treatment, which not only simplifies the manufacturing process, but also avoids the use of complex, expensive and time-consuming acid etching or lithography processes in semiconductor manufacturing processes, and reduces environmental pollution.

Specifically, the present invention electrochemically treats an aluminum foil in an electrolyte within a specific temperature range and modifies the surface structure of the aluminum foil to create three-dimensional cavities. The specific temperature range is 15 to 25° C., preferably 15 to 20° C.

Accordingly, an aspect of the present invention provides a method of manufacturing an SERS substrate, comprising:
(A) a cleaning step: cleaning an aluminum foil;
(B) a first electrochemical treatment step: electrochemically treating the aluminum foil by applying 5 to 40 V direct current (DC) voltage to the aluminum foil in an electrolyte at a temperature of 15 to 25° C. to change the surface structure of the aluminum foil;
(C) a second electrochemical treatment step: further electrochemically treating the aluminum foil with hybrid pulse square wave to obtain an AAO substrate;
(D) a metal plating step: plating a layer of metal on a surface of the AAO substrate to form a metal nano-film;
   with the first electrochemical treatment step carried out at 15 to 25° C. to prepare three-dimensional cavities, and a total of two electrochemical treatment steps to change the surface structure of the AAO, so that the sensing capability of the SERS substrate may be enhanced.

Furthermore, another aspect of the present invention provides a method of manufacturing an SERS substrate, comprising:
(A) a first electrochemical treatment step: electrochemically treating an aluminum foil by applying 5 to 40 V DC voltage to the aluminum foil in an electrolyte at a temperature of 15 to 25° C. to change the surface structure of the aluminum foil;
(B) a second electrochemical treatment step: further electrochemically treating the aluminum foil with hybrid pulse square wave to obtain an aluminum foil with an AAO film;
(C) a third electrochemical treatment step: electrochemically treating the aluminum foil with the AAO film in a 5 wt % phosphoric acid electrolyte to obtain an AAO substrate;
(D) a metal plating step: plating a layer of metal on a surface of the AAO substrate to form a metal nano-film;
   with the first electrochemical treatment step carried out at 15 to 25° C. to prepare three-dimensional cavities, and the third electrochemical treatment step to change the surface structure of the AAO by pore widening, where the sizes of the nanopores in the three-dimensional cavities are enlarged and the distances between the nanopores are reduced, so that the sensing capability of the SERS substrate may be increased and the Raman signals may be enhanced.

Furthermore, another aspect of the present invention provides a method of manufacturing an SERS substrate, comprising:
(A) a first electrochemical treatment step: electrochemically treating an aluminum foil by applying 5 to 40 V DC voltage to the aluminum foil in an electrolyte at a temperature of −20 to 20° C. to change the surface structure of the aluminum foil;
(B) a second electrochemical treatment step: further electrochemically treating the aluminum foil with hybrid pulse square wave to obtain an aluminum foil with an AAO film;
(C) a third electrochemical treatment step: electrochemically treating the aluminum foil with the AAO film in an electrolyte consisting of ethanol and perchloric acid to separate the AAO film and the aluminum foil and obtain the AAO substrate with nanospikes;
(D) a metal plating step: plating a layer of metal on a surface of the AAO substrate to form a metal nano-film;
   with a total of three electrochemical treatment steps to change the surface structure of the AAO, so that the sensing capability of the SERS substrate may be enhanced; wherein with the third electrochemical treatment step, an AAO substrate with three dimensional cavities comprising nanospikes may be obtained, which may enhance the three-dimensionality of the cavities structure of the AAO substrate to enhance the Raman signals.

Furthermore, another aspect of the present invention provides a method of manufacturing an SERS substrate, comprising:
(A) a cleaning step: cleaning an aluminum foil;
(B) a first electrochemical treatment step: electrochemically treating the aluminum foil by applying 5 to 40 V DC voltage to the aluminum foil in an electrolyte at a temperature of 15 to 25° C. to change the surface structure of the aluminum foil;
(C) a second electrochemical treatment step: further electrochemically treating the aluminum foil with hybrid pulse square wave to obtain an aluminum foil with an AAO film;
(D) a step of removing the AAO film; placing the aluminum foil with the AAO film in a mixed solution consisting of phosphoric acid and chromic acid to remove the AAO film, and obtain an aluminum foil with a surface structure;
(E) a third electrochemical treatment step: electrochemically treating the aluminum foil with the surface structure with hybrid pulse square wave to obtain an AAO substrate;
(F) a metal plating step: plating a layer of metal on a surface of the AAO substrate to form a metal nano-film;
   with the step of removing the AAO film and the third electrochemical treatment to modify the morphology of the AAO substrate with three-dimensional cavities and enhance the three-dimensionality of the cavities structure of the AAO substrate for enhancing the Raman signals: moreover, with the first electrochemical treatment step carried out at 15 to 25° C., the surface structure of the aluminum foil may be changed and the AAO substrate with three-dimensional cavities may be prepared, so that the sensing capability of the SERS substrate may be enhanced.

In some embodiments, in (C) the second electrochemical treatment step of electrochemically treating the aluminum foil with hybrid pulse square wave: phosphoric acid, oxalic acid, sulfuric acid, or a combination thereof is used as an electrolyte and the aluminum foil is electrochemically treated for 3 to 5 minutes at 0 to 40° C. with a positive pulse of 10 to 200V and a negative pulse of −2 to −8 V, where the time ratio of the positive pulse to the negative pulse is 1:1 to 1:4. With this step, an AAO may be obtained and the SERS sensing capability may be enhanced. The voltage used may vary with different acids: phosphoric acid: positive pulse of 100 to 200 V, negative pulse of −2 to −8 V: oxalic acid: positive pulse of 100 to 150 V, negative pulse of −2 to −8 V: sulfuric acid: positive pulse of 10 to 60 V, negative pulse of −2 to −4 V.

The SERS substrate of the present invention adopts a metal nano-film to generate a surface plasmonic resonance structure, which avoids changes in the shape and gap of the metal-nanoparticles after laser illumination, and improves the stability, reproducibility, and uniformity of the SERS substrate.

The SERS substrate of the present invention comprises an AAO substrate with three-dimensional cavities obtained by specific electrochemical treatment steps, so that multi-reflection may occur during laser illumination, which allows more photons to collide with the probe molecules on the SERS substrate inelastically and amplifies the magnitude of Raman signals, to avoid the disadvantage of AAO substrates with two-dimensional structure that has a poorer sensitivity.

The method of manufacturing a SERS substrate of the present invention overcomes the shortcomings of being time-consuming and expensive for the existing SERS substrate manufacturing process, and enables rapid production and low cost, so that AAO substrates may be disposed of after test without reuse, and the simple process also has a great advantage for mass production.

The SERS substrate of the present invention is highly sensitive and stable, and is suitable for industries that require water quality testing, such as sewage treatment and ecological conservation: samples may be collected directly in the field, titrated on the SERS substrate, dried, and then subjected to a precise SERS test, so as to analyze what substances the samples contain, and whether or not they comply with the international standards.

The screening of additives and the detection of adulterated raw materials is an important industry to ensure food safety: with the SERS substrate of the present invention, it can be directly and rapidly detected that what ingredients are contained in food and whether there is any illegal additive, etc.; and the SERS substrate of the present invention has a lower detection limit, which ensures that illegal additives can be detected. Further, the SERS substrate of the present invention may also be used in the agricultural research industry for analyzing the composition of pesticides and conducting breed identification to screen the types and concentrations of pesticide residues on the surface of fruits and vegetables. It should be of great help in the control of illegal use of pesticides or excessive drug residues.

The SERS substrate of the present invention may also be applicable to the medical field for analyzing cancer cells, DNA viruses and other biomolecules that need to be detected: for example, if an SERS database of different types of cells is established, the distribution pattern of normal cells and cancer cells may be statistically analyzed and the spectrum of cancer cells may be determined. The SERS substrate of the invention may then be applied to fields such as drug screening or disease diagnosis.

### BRIEF DESCRIPTION OF THE DRAWINGS

FIG. 1 shows the SEM micrograph of AAO-R5.

FIG. 2 shows the SEM micrograph of AAO-R15.

FIG. 3 shows the SEM micrograph of AAO-R20.

FIG. 4 shows the SEM micrograph of AAO-R20 at higher magnification.

FIG. 5 shows SERS spectra of 10⁻⁵ M methylene blue measured by SERS substrates with AAO-R5, AAO-R10, AAO-R15, and AAO-R20.

FIG. 6 shows SERS spectra of methylene blue with various concentrations measured by a SERS substrate with AAO-R20.

FIG. 7 shows SERS spectra of melamine with various concentrations measured by a SERS substrate with AAO-R20.

### DETAILED DESCRIPTION

The present invention adopts aluminum foil processed with several electrochemical treatment steps. Specifically, the aluminum foil is electrochemically treated in an electrolyte at a specific temperature range to prepare a SERS substrate that does not contain metal-nanoparticles. The SERS substrate comprises an AAO substrate with three-dimensional cavities, wherein the three-dimensional cavities with high roughness comprise nano-and-micro-scale pits with small nanopores, or nanospikes around nanocavities, so that multi-reflection may occur during laser illumination, and may allow more photons to collide inelastically with the probe molecules, and thereby amplify Raman signals. Moreover, the AAO substrate is coated with a layer of metal to generate localized surface plasmonic resonance. Accordingly, the SERS substrate of the present invention has high stability, high reproducibility, high uniformity, and high sensitivity.

The present invention will be explained through the following Examples. The Examples of the present invention are only for listing possible embodiments, but not intended to limit the present invention to be implemented in accordance with any specific conditions, applications or specific methods described in the Examples. Thus, the illustration of Examples is only for the purpose of explaining the present invention and not intended to limit the present invention.

### EXAMPLES

### Example 1

### [Preparation]

### 1. Cleaning Step:

An aluminum foil is ultrasonically cleaned in acetone and deionized water for 5 minutes to remove surface particles and oily dirt, and the surface of the aluminum substrate is rinsed with deionized water, and then blown dry with nitrogen.

### 2. A First Electrochemical Treatment Step:

The aluminum foil is electrochemically treated at different temperatures of 5° C., 10° C., 15° C. and 20° C., respectively, by applying 20 V DC voltage to the aluminum foil for 5 minutes in an electrolyte consisting of perchloric acid and ethanol, so that the aluminum foils R5, R10, R15, and R20 with three-dimensional cavities with different surface structures are obtained. In particular, it was found through several experiments that a temperature higher than 25° C. would result in poor SERS uniformity, and therefore the ideal temperature is 20° C.

### 3. A Second Electrochemical Treatment Step:

The aluminum foils are anodized in an electrolyte which is a 5 wt % phosphoric acid at 25° C. using one-step hybrid pulse anodization (HPA) (Jiehan 5000) for 180 seconds with a positive voltage of 120 V and a negative voltage of −4 V, so that the AAO substrates are obtained (AAO-R5, AAO-R10, AAO-R15, AAO-R20).

### 4. A Metal Plating Step:

The surfaces of the AAO substrates with three-dimensional cavities are sputtered with a platinum film with a thickness of about 15 nm by a sputter (JEC-3000FC, JEOL Co., Ltd.), and the SERS substrates for SERS sensing are obtained.

### [Analysis]

### 1. The Roughness of R5 to R20 is Measured by the α-Step Profiler (Kosaka Lab, ET3000):

The average roughness of R5, R10, R15 and R20 is 0.18, 0.48, 0.82, and 0.91 μm, respectively. Accordingly, it may be known that in the first electrochemical treatment, the higher electrolyte temperature leads to the faster reaction which causes local over-etching for more significant cavities and depressions on the aluminum foils, and increases the three-dimensionality of the cavities. Moreover, the average roughness of the aluminum foils obtained from the first electrochemical treatment step at 15° C. and 20° C. is much higher than that of the aluminum foils treated at 5° C. and 10° C.

### 2. The Nanostructures of the AAO are Observed by a High-Resolution Field-Emission-Scanning-Electron Microscope (HR-FESEM, JEOL JSM-7001):

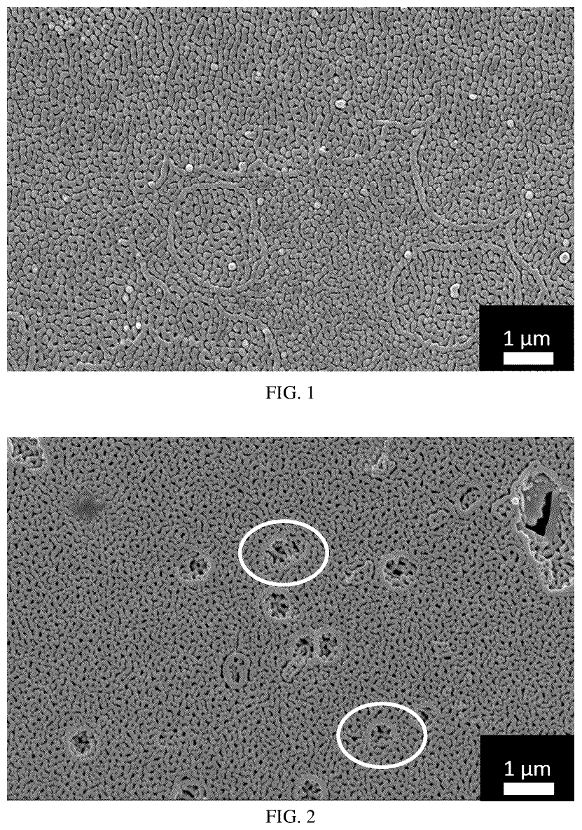

FIGS. 1, 2, 3 show the SEM micrographs of AAO-R5, AAO-R15 and AAO-R20. First, in FIG. 1, the surface of AAO-R5 is smooth, where the electric field distributes evenly. In contrast, as shown in FIG. 2, a number of micron-scale cavities can be clearly observed on the surface of AAO-R15, which are larger in extent and darker in color contrast (i.e., the three-dimensional structure is more obvious) than AAO-R5.

Moreover, there are a micron-scale pit and a nano-scale pit in the two places circled in FIG. 2 respectively. Observing the micron-scale pit in the upper circle, a contrasting color change may be seen, i.e., there is a difference in depth. The black dots in the pits are nanopores, so the micron-scale pit in the upper circle is a three-dimensional cavity structure composed of several to tens nanopores. In addition, the nano-scale pit in the lower circle can be observed to have contrasting color changes, i.e., there is a difference in depth, and the black dots in the pit are nanopores, so the nano-scale pit in the lower circle is a three-dimensional cavity structure composed of several to tens nanopores. The surface roughness is further increased by the above three-dimensional cavity structure, which is more obvious in FIG. 4 below.

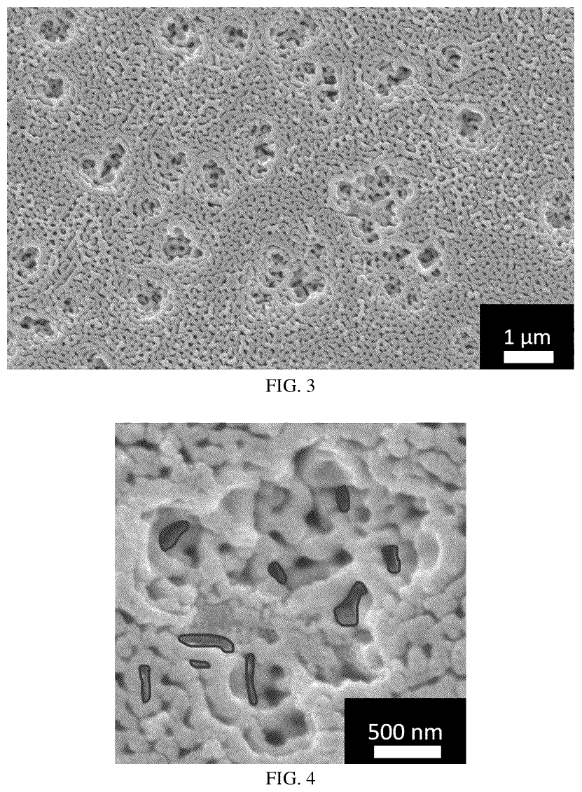

Then, when the reaction temperature of the first electrochemical treatment step is further raised to 20° C., as shown in FIG. 3, the number and size of the etched micron-scale pits and nano-scale pits increase more significantly, and there is a phenomenon of pit aggregation. Accordingly, the three-dimensional cavity structure of the SERS substrate is more significant, which may help to cause multi-reflections, generating more inelastic collisions of photons with the probe molecules and thus increasing the Raman signals.

FIG. 4 shows the SEM micrograph of AAO-R20 at higher magnification. From FIG. 4, the three-dimensional cavity structure of AAO substrate may be more clearly observed to have a lot of nanopores as circled in FIG. 4 in nano-and-micro-scale pits. Accordingly, the AAO substrate, which is prepared from the aluminum foil with distinctive cavities and depressions, has a three-dimensional cavity structure, which is conducive to multi-reflections and scattering reactions, and thus enhances the Raman signals during detection.

3. The Gaps Between the Nanopores are Measured with Image J Software:

Image J software is used to measure the gaps between the nanopores in the nano-and -micro-scale pits of AAO-R5, AAO-R10, AAO-R15, and AAO-R20. The gap is defined as the distance between the outermost part of one nanopore to that of another nanopore. The average gap of AAO-R5, AAO-R10, AAO-R15, and AAO-R20 is measured to be 100 to 300 nm.

### 4. Raman Spectral Measurements:

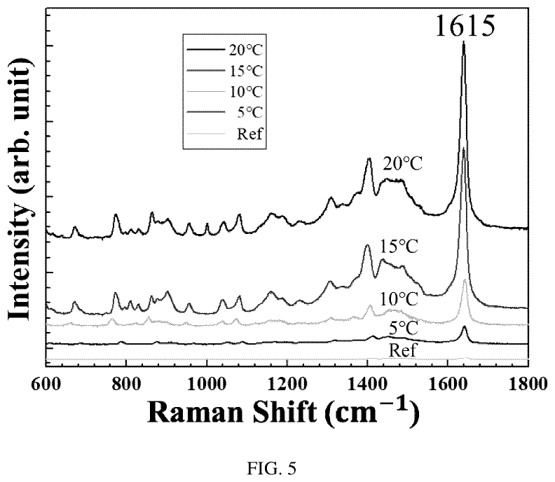

The SERS substrates with AAO-R5, AAO-R10, AAO-R15, and AAO-R20 are used to measure 10⁻⁵ M methylene blue, and 0.1 M methylene blue is dropped on a smooth silicon substrate plated with platinum as a control group. The measured Raman spectra are compared. The result is shown in FIG. 5, which shows that the surface with high roughness and three-dimensional cavity structure with high dimensionality has better effect of sensing.

Moreover, as shown in FIG. 5, the signal intensities of Raman spectra at 1615 cm⁻¹ measured by the SERS substrates with AAO-R5, AAO-R10, AAO-R15, AAO-R20 and the control group are 4643, 10844, 40122, 48413, 421, respectively. It is shown that AAO-R15 and AAO-R20, which have obvious three-dimensional cavity structures, can enhance the Raman signals, with the maximum strength nearly 100 times more than that of the control group.

### 5. Detection Limit of Methylene Blue:

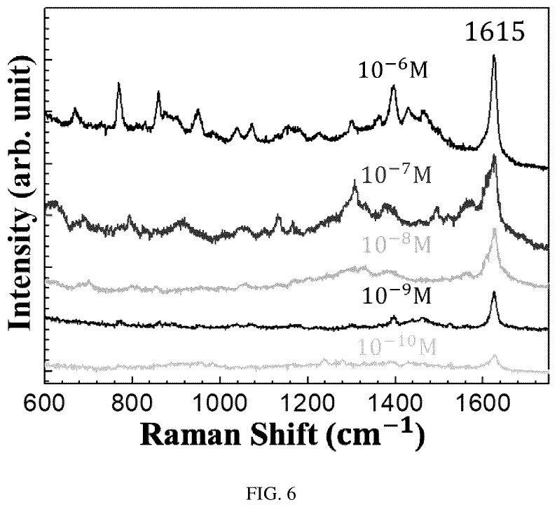

The SERS substrate with AAO-R20 is used to measure methylene blue solution with concentrations of 10⁻⁶ M, 10⁻⁷ M, 10⁻⁸ M, 10⁻⁹ M, and 10⁻¹⁰ M. The results of SERS spectra are shown in FIG. 6, which shows that the methylene blue solution of 10⁻¹⁰ M has an obvious signal at 1615 cm⁻¹, indicating that the detection limit of methylene blue may be as low as 10⁻¹⁰ M by using the SERS substrate with a three-dimensional cavity structure, which is of high applicability.

### 6. Detection Limit of Melamine:

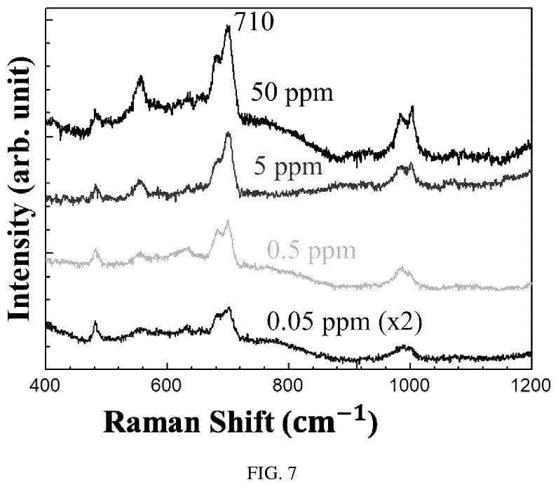

The SERS substrate with AAO-R20 is used to measure melamine solution with concentrations of 50 ppm, 5 ppm, 0.5 ppm, and 0.05 ppm. The results of SERS spectra are shown in FIG. 7, which shows that the melamine solution of 0.05 ppm also has an obvious signal at 710 cm⁻¹, indicating that the detection limit of melamine may be as low as 0.05 ppm, which is much lower than the WHO-recommended criteria, 1 ppm, by using the SERS substrate with a three-dimensional cavity structure, which is of high applicability.

### Example 2

### 1. Cleaning Step:

An aluminum foil is ultrasonically cleaned in acetone and deionized water for 5 minutes to remove surface particles and oily dirt, and the surface of the aluminum substrate is rinsed with deionized water, and then blown dry with nitrogen.

### 2. A First Electrochemical Treatment Step:

The aluminum foil is electrochemically treated at 15° C. to 25° C. by applying 5 to 40 V DC voltage to the aluminum foil for 5 minutes in a mixed solution consisting of perchloric acid and ethanol (4:1-1:4), so that the aluminum foil with three-dimensional cavity structure is obtained.

### 3. A Second Electrochemical Treatment Step:

The aluminum foil is secondly electrochemically treated in an electrolyte of 5 wt % phosphoric acid at 0-40° C. for 180 seconds using hybrid pulse square wave consisting of a positive voltage of 100 to 200 V and a negative voltage of −2 to −8 V, where the time ratio of the positive and negative voltage is 1:1-1:4. Then, the porous AAO film is obtained.

### 4. A Third Electrochemical Treatment Step:

Afterwards, the hybrid pulse square wave is suspended and the reaction continues in the electrolyte for 0-60 minutes to obtain an AAO substrate.

### 5. A Metal Plating Step:

The surface of the AAO substrate is plated with a metal film with a thickness of about 6 to 30 nm, and the SERS substrate for SERS sensing is obtained.

In this example, the first electrochemical treatment step is carried out at 15-25° C. to prepare a three-dimensional cavity structure, and the third electrochemical treatment step is carried out to further adjust the morphology of the AAO substrate with the three-dimensional cavity structure by widening the size of the nanopores therein and decreasing the distance between the nanopores therein, so as to enhance the three-dimensionality of the cavities structure of the AAO substrate to strengthen the Raman signals. Specifically, Image J software is used to measure the gaps between the nanopores after the pore widening. The gap is defined as the distance between the outermost part of one nanopore to that of another nanopore. The average gap is measured to be 10 to 100 nm. Accordingly, it can be seen that the third electrochemical treatment step for pore widening has indeed reduced the average gap from 100-300 nm to 10-100 nm, which enhances the three-dimensionality of the cavities structure of the AAO substrate.

### Example 3

### 1. Cleaning Step:

An aluminum foil is ultrasonically cleaned in acetone and deionized water for 5 minutes to remove surface particles and oily dirt, and the surface of the aluminum substrate is rinsed with deionized water, and then blown dry with nitrogen.

### 2. A First Electrochemical Treatment Step:

The aluminum foil is electrochemically treated at −20° C. to 20° C. by applying 5 to 40 V DC voltage to the aluminum foil for 5 minutes in a mixed solution consisting of perchloric acid and ethanol (4:1-1:4), so that an aluminum foil with an average roughness (Ra) of 0.05 to 1 μm is obtained.

### 3. A Second Electrochemical Treatment Step:

The aluminum foil is secondly electrochemically treated in an electrolyte of 0.1-3 M oxalic acid at 0-40° C. for 5 minutes using hybrid pulse square wave consisting of a positive voltage of 100 to 150 V and a negative voltage of −2 to 8 V, where the time ratio of the positive and negative voltage is 1:1-1:4. Then, an aluminum foil with an AAO film is obtained.

### 4. A Third Electrochemical Treatment Step:

The aluminum foil with the AAO film is electrochemically treated by applying 120 to 180 V DC voltage to the aluminum foil for 30 seconds in an electrolyte consisting of perchloric acid and ethanol (4:1-1:4) to separate the AAO film and the aluminum foil and obtain the AAO substrate with three-dimensional spikes.

### 5. A Metal Plating Step:

The surface of the AAO substrate with three-dimensional spikes is plated with a metal film with a thickness of about 6 to 30 nm, and the SERS substrate for SERS sensing is obtained.

In this example, the third electrochemical treatment step is used to obtain an AAO substrate with a three-dimensional cavity structure with nanospikes, which enhances the three-dimensionality of the cavities structure of the AAO substrate, and thus improves the sensing capability of the SERS substrate.

### Example 4

### 1. Cleaning Step:

An aluminum foil is ultrasonically cleaned in acetone and deionized water for 5 minutes to remove surface particles and oily dirt, and the surface of the aluminum substrate is rinsed with deionized water, and then blown dry with nitrogen.

### 2. A First Electrochemical Treatment Step:

The aluminum foil is electrochemically treated at 15° C. to 20° C. by applying 5 to 40 V DC voltage to the aluminum foil for 5 minutes in a mixed solution consisting of perchloric acid and ethanol (4:1-1:4), so that an aluminum foil with an average roughness (Ra) of 0.05 to 1 μm is obtained.

### 3. A Second Electrochemical Treatment Step:

The aluminum foil is secondly electrochemically treated in an electrolyte of 0.1-3 M oxalic acid at 0-40° C. for 1-60 minutes using hybrid pulse square wave consisting of a positive voltage of 100 to 150 V and a negative voltage of −2 to 8 V, where the time ratio of the positive and negative voltage is 1:1-1:4. Then, an AAO substrate is obtained.

### 4. A Step of Removing the AAO Film:

The AAO substrate is placed in a mixed solution consisting of phosphoric acid and chromic acid (1-4 wt % of chromic acid and 3-10 wt % of phosphoric acid) to remove the AAO film of the AAO substrate, and re-obtain the aluminum foil with a surface structure.

### 5. A Third Electrochemical Treatment Step:

The aluminum foil is electrochemically treated in an electrolyte of 0.1-3 M oxalic acid at 0-40° C. for 1-60 minutes using hybrid pulse square wave consisting of a positive voltage of 100 to 150 V and a negative voltage of −2 to 8 V, where the time ratio of the positive and negative voltage is 1:1-1:4, and the AAO substrate with large and small pores is obtained.

### 6. A Metal Plating Step:

The surface of the AAO substrate is plated with a metal film with a thickness of about 6 to 30 nm, and the SERS substrate for SERS sensing is obtained.

In this example, a three-dimensional cavity structure is prepared by the first electrochemical treatment step at 15-25° C., and the morphology of the AAO substrate with a three-dimensional cavity structure may be adjusted by the step of removing the AAO film and the third electrochemical treatment step in order to enhance the three-dimensionality of the cavities structure of the AAO substrate, strengthen the Raman signals, and thus improve the sensing capability of the SERS substrate.

In summary, as can be seen from the above description of the means and examples, the present invention has the following breakthroughs and advantages over the prior arts:

The SERS substrate of the present invention adopts a metal nano-film to avoid changes in the shape and gap of the metal-nanoparticles after laser illumination, thus improving the stability, reproducibility and uniformity of the SERS substrate.

The SERS substrate of the present invention has an AAO substrate with three-dimensional cavities obtained by specific electrochemical treatments. Specifically, the surface structure of aluminum foil or AAO is modified by electrochemical treatment at a specific temperature range to produce AAO substrates with three-dimensional cavities, so that multi-reflection may occur during laser illumination, and may allow more photons to collide inelastically with the probe molecules on the SERS substrate, and thereby amplify Raman signals, avoiding the disadvantage of AAO substrate with two-dimensional structure that has a poor sensitivity.

The method of manufacturing the SERS substrate of the present invention solves the time-consuming and expensive shortcomings of the existing SERS substrate manufacturing process, and enables rapid production at low cost, so that the AAO substrate may be disposed of after test without reuse, and the simplified process also has a great advantage for mass production.

The SERS substrate of the present invention is highly sensitive and stable, and is suitable for use in industries requiring water quality testing, such as wastewater treatment, ecological conservation and agricultural research like analyzing the composition of pesticides and identifying varieties, and also, in drug screening or disease diagnosis.

What is claimed is:

1. A metal-nanoparticle-free surface-enhanced Raman scattering substrate, comprising:
an anodic aluminum oxide substrate with three-dimensional cavities; and
a metal nano-film on the anodic aluminum oxide substrate;
the three-dimensional cavities comprise nano-and-micro-scale pits with nanopores, or nanospikes around nanocavities; and the metal nano-film is on the three-dimensional cavities.

2. The metal-nanoparticle-free surface-enhanced Raman scattering substrate of claim 1, wherein the nano-and-micro-scale pits of the three-dimensional cavities have an average diameter of 0.1 to 5 μm.

3. The metal-nanoparticle-free surface-enhanced Raman scattering substrate of claim 1, wherein the anodic aluminum oxide substrate has an average roughness of 0.1 to 2 μm.

4. The metal-nanoparticle-free surface-enhanced Raman scattering substrate of claim 1, wherein the metal nano-film has a thickness of 6 to 30 nm.

5. The metal-nanoparticle-free surface-enhanced Raman scattering substrate of claim 1, wherein the nanopores have an average gap between the nanopores of 10 to 300 nm.

6. The metal-nanoparticle-free surface-enhanced Raman scattering substrate of claim 1, wherein the metal-nanoparticle-free surface-enhanced Raman scattering substrate has a low detection limit of 0.05 ppm for melamine; and the metal-nanoparticle-free surface-enhanced Raman scattering substrate has a low detection limit of 1×10⁻¹⁰ M for methylene blue.

7. The metal-nanoparticle-free surface-enhanced Raman scattering substrate of claim 2, wherein the metal-nanoparticle-free surface-enhanced Raman scattering substrate has a low detection limit of 0.05 ppm for melamine; and the metal-nanoparticle-free surface-enhanced Raman scattering substrate has a low detection limit of 1×10⁻¹⁰ M for methylene blue.

8. The metal-nanoparticle-free surface-enhanced Raman scattering substrate of claim 3, wherein the metal-nanoparticle-free surface-enhanced Raman scattering substrate has a low detection limit of 0.05 ppm for melamine; and the metal-nanoparticle-free surface-enhanced Raman scattering substrate has a low detection limit of 1×10⁻¹⁰ M for methylene blue.

9. The metal-nanoparticle-free surface-enhanced Raman scattering substrate of claim 4, wherein the metal-nanoparticle-free surface-enhanced Raman scattering substrate has a low detection limit of 0.05 ppm for melamine; and the metal-nanoparticle-free surface-enhanced Raman scattering substrate has a low detection limit of 1×10⁻¹⁰ M for methylene blue.

10. A method of manufacturing the metal-nanoparticle-free surface-enhanced Raman scattering substrate of claim 1, comprising:
(A) a first electrochemical treatment step: electrochemically treating an aluminum foil by applying a 5 to 40 V direct current voltage to the aluminum foil in an electrolyte at a temperature of 15 to 25° C. to change a surface structure of the aluminum foil;
(B) a second electrochemical treatment step: further electrochemically treating the aluminum foil with hybrid pulse square wave to obtain the anodic aluminum oxide substrate;
(C) a metal plating step: plating a layer of metal on a surface of the anodic aluminum oxide substrate to form the metal nano-film.

11. A method of manufacturing the metal-nanoparticle-free surface-enhanced Raman scattering substrate of claim 1, comprising:
(A) a first electrochemical treatment step: electrochemically treating an aluminum foil by applying 5 to 40 V direct current voltage to the aluminum foil in an electrolyte at a temperature of 15 to 25° C. to change a surface structure of the aluminum foil;
(B) a second electrochemical treatment step: further electrochemically treating the aluminum foil with hybrid pulse square wave to obtain an aluminum foil with an anodic aluminum oxide film;
(C) a third electrochemical treatment step: electrochemically treating the aluminum foil with the anodic aluminum oxide film in a 5 wt % phosphoric acid electrolyte to obtain the anodic aluminum oxide substrate;
(D) a metal plating step: plating a layer of metal on a surface of the anodic aluminum oxide substrate to form the metal nano-film.

12. A method of manufacturing the metal-nanoparticle-free surface-enhanced Raman scattering substrate of claim 1, comprising:
(A) a first electrochemical treatment step: electrochemically treating an aluminum foil by applying 5 to 40 V direct current voltage to the aluminum foil in an electrolyte at a temperature of −20 to 20° C. to change a surface structure of the aluminum foil;
(B) a second electrochemical treatment step: further electrochemically treating the aluminum foil with hybrid pulse square wave to obtain an aluminum foil with an anodic aluminum oxide film;
(C) a third electrochemical treatment step: electrochemically treating the aluminum foil with the anodic aluminum oxide film in an electrolyte consisting of ethanol and perchloric acid to separate the anodic aluminum oxide film and the aluminum foil, and obtain the anodic aluminum oxide substrate with the nanospikes;
(D) a metal plating step: plating a layer of metal on a surface of the anodic aluminum oxide substrate to form the metal nano-film.

13. A method of manufacturing the metal-nanoparticle-free surface-enhanced Raman scattering substrate of claim 1, comprising:
(A) a first electrochemical treatment step: electrochemically treating an aluminum foil by applying 5 to 40 V direct current voltage to the aluminum foil in an electrolyte at a temperature of 15 to 25° C. to change a surface structure of the aluminum foil;
(B) a second electrochemical treatment step: further electrochemically treating the aluminum foil with hybrid pulse square wave to obtain an aluminum foil with an anodic aluminum oxide film;
(C) a step of removing the anodic aluminum oxide film; placing the aluminum foil with the anodic aluminum oxide film in a mixed solution consisting of phosphoric acid and chromic acid to remove the anodic aluminum oxide film, and obtain an aluminum foil with a surface structure;
(D) a third electrochemical treatment step: electrochemically treating the aluminum foil with the surface structure with hybrid pulse square wave to obtain the anodic aluminum oxide substrate;
(E) a metal plating step: plating a layer of metal on a surface of the anodic aluminum oxide substrate to form the metal nano-film.
